(19) United States
(12) Patent Application Publication
(10) Pub. No.: US 2011/0234838 A1
(43) Pub. Date: Sep. 29, 2011

(54) IMAGE PROCESSOR, ELECTRONIC CAMERA, AND IMAGE PROCESSING PROGRAM

(75) Inventors: Hitomi NAGANUMA, Kawasaki-Shi (JP); Asuka NAKAMURA, Tokyo (JP); Yuya ADACHI, Tokyo (JP)

(73) Assignee: NIKON CORPORATION, Tokyo (JP)

(21) Appl. No.: 13/050,266

(22) Filed: Mar. 17, 2011

(30) Foreign Application Priority Data
Mar. 26, 2010 (JP) 2010-073757
Feb. 9, 2011 (JP) 2011-026304

(51) Int. Cl. H04N 5/228; G06K 9/32

(52) U.S. Cl. 348/222.1; 382/294; 348/E05.031

(57) ABSTRACT

An image processor including an acquisition unit and a moving image generation unit. The acquisition unit acquires image analysis information of a feature in an image. The moving image generation unit generates a moving image superimposed and displayed on the image so that the moving image is displayed in a pattern that changes in accordance with the image analysis information acquired by the acquisition unit.

### CROSS-REFERENCE TO RELATED APPLICATIONS

This application is based upon and claims the benefit of priority from prior Japanese Patent Application Nos. 2010-73757, filed on Mar. 26, 2010, and 2011-026304, filed on Feb. 9, 2011, the entire contents of which are incorporated herein by reference.

### BACKGROUND ART

The present invention relates to an image processor that superimposes and shows a moving image on an image, an electronic camera including the image processor, and an image processing program.

An image captured by an electronic camera, such as a digital still camera, may undergo a special effect process that is known in the art. For example, Japanese Laid-Open. Patent Publication No. 2008-84213 describes an electronic camera that detects facial expressions of a human subject included in a captured image. The electronic camera then performs a special effect process on the captured image by, for example, combining a certain graphic image with the captured image in accordance with the detected information.

### SUMMARY OF THE INVENTION

A recent special effect process superimposes and shows a moving image on a captured image. This adds a dynamic decoration on a captured image. The superimposed moving image may always be of the same type graphic image. However, by changing the movement pattern of the graphic image, a different dynamic effect may be added to the captured image.

However, when an electronic camera of the prior art performs a special effect process that combines a captured image with a moving image, the electronic camera selects a moving image from a plurality of moving images and combines the selected moving image with the captured image. The moving images each have a movement pattern that is set in advance. This imposes limitations on the movement pattern of each moving image that can be combined with a captured image. Thus, it becomes difficult to add a wide variety of moving image effects on each captured image, the contents of which varies greatly.

One aspect of the present invention is an image processor including an acquisition unit that acquires image analysis information of a feature in an image. A moving image generation unit generates a moving image superimposed and displayed on the image so that the moving image is displayed in a pattern that changes in accordance with the image analysis information acquired by the acquisition unit.

A further aspect of the present invention is an image processor including an acquisition unit that obtains feature information of a feature in an image. A moving image generation unit generates a moving image superimposed and displayed on the image so that the moving image is displayed in a pattern that changes in accordance with the feature information acquired by the acquisition unit.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing the circuit configuration of a digital camera;

FIG. 2 is a flowchart illustrating a moving image superimposing routine according to a first embodiment of the present invention;

FIG. 3 is a flowchart illustrating an image analysis routine;

FIG. 4(a) is a schematic diagram showing a monitor screen immediately after a cartoon character appears, FIG. 4(b) is a schematic diagram showing the monitor screen on which the cartoon character is moving toward an AF area, FIG. 4(c) is a schematic diagram showing the monitor screen on which the cartoon character moves its face to the AF area, and FIG. 4(d) is a schematic diagram showing the monitor screen immediately before the cartoon character disappears;

FIG. 5(a) is a schematic diagram showing a monitor screen immediately after a cartoon character appears, FIG. 5(b) is a schematic diagram showing the monitor screen on which the cartoon character is moving toward a main subject, FIG. 5(c) is a schematic diagram showing the monitor screen on which the cartoon character moves its face to the main subject, and FIG. 5(d) is a schematic diagram showing the monitor screen immediately before the cartoon character disappears;

FIG. 6(a) is a schematic diagram showing a monitor screen immediately after a cartoon character appears, FIG. 6(b) is a schematic diagram showing the monitor screen on which the cartoon character is moving toward an AF area, FIG. 6(c) is a schematic diagram showing the monitor screen on which the cartoon character is passing through the AF area, and FIG. 6(d) is a schematic diagram showing the monitor screen immediately before the cartoon character disappears;

FIG. 7 is a flowchart illustrating an imaging routine according to a second embodiment of the present invention;

FIG. 8 is a flowchart illustrating a moving image superimposing routine in the second embodiment;

FIG. 9(a) is a schematic diagram showing a monitor screen immediately after a cartoon character appears, FIG. 9(b) is a schematic diagram showing the monitor screen on which the cartoon character is moving toward a first subject, FIG. 9(c) is a schematic diagram showing the monitor screen on which the cartoon character moves its face to the first subject, FIG. 9(d) is a schematic diagram showing the monitor screen on which the cartoon character is moving toward a second subject, and FIG. 9(e) is a schematic diagram showing the monitor screen on which the cartoon character moves its face to the second subject;

FIG. 10(a) is a schematic diagram showing a monitor screen immediately after a cartoon character appears, FIG. 10(b) is a schematic diagram showing the monitor screen on which the cartoon character is moving toward an AF area, FIG. 10(c) is a schematic diagram showing the monitor screen on which the cartoon character is moving in a manner to avoid the AF area, and FIG. 10(d) is a schematic diagram showing the monitor screen on which the cartoon character is moving away from the AF area;

FIG. 11 is a flowchart illustrating a moving image superimposing routine according to a third embodiment of the present invention;

FIG. 12 is a flowchart illustrating a first image analysis routine in the third embodiment;

FIG. 13 is a schematic diagram showing a white cartoon character is superimposed on an image of which entire background is black;

FIG. 14 is a flowchart illustrating a first image analysis routine according to a fourth embodiment of the present invention;

FIG. 15 is a schematic diagram showing a cross screen filter effect added to an image of which scene information indicates “night scene portrait”;

FIG. 16 is a schematic diagram showing a cartoon character wearing sunglasses superimposed on an image of which scene information indicates “ocean”;

FIG. 17 is a schematic diagram showing a cartoon character wearing a coat superimposed on an image of which scene information indicates “snow”;

FIG. 18 is a flowchart illustrating a first image analysis routine according to a fifth embodiment of the present invention;

FIG. 19 is a schematic diagram showing a butterfly character superimposed on an image of which main subject is a flower;

FIG. 20 is a flowchart illustrating a first image analysis routine according to a sixth embodiment of the present invention;

FIG. 21 is a schematic diagram showing a monkey character superimposed on an image of which main subject includes the Japanese characters for “Nikko Toshogu”;

FIG. 22 is a flowchart illustrating a first image analysis routine according to a seventh embodiment of the present invention;

FIG. 23 is a schematic diagram showing metadata associated with an image;

FIG. 24 is a schematic diagram showing a cartoon character wearing a coat with the flag of the rising sun superimposed on an image of which imaging capturing location indicates Japan;

FIG. 25 is a flowchart illustrating a first image analysis routine according to an eighth embodiment of the present invention; and

FIG. 26 is a schematic diagram showing a cartoon character dressed as Santa Clause superimposed on an image of which image capturing information indicates the 25th of December.

### DETAILED DESCRIPTION OF THE PREFERRED EMBODIMENTS

### First Embodiment

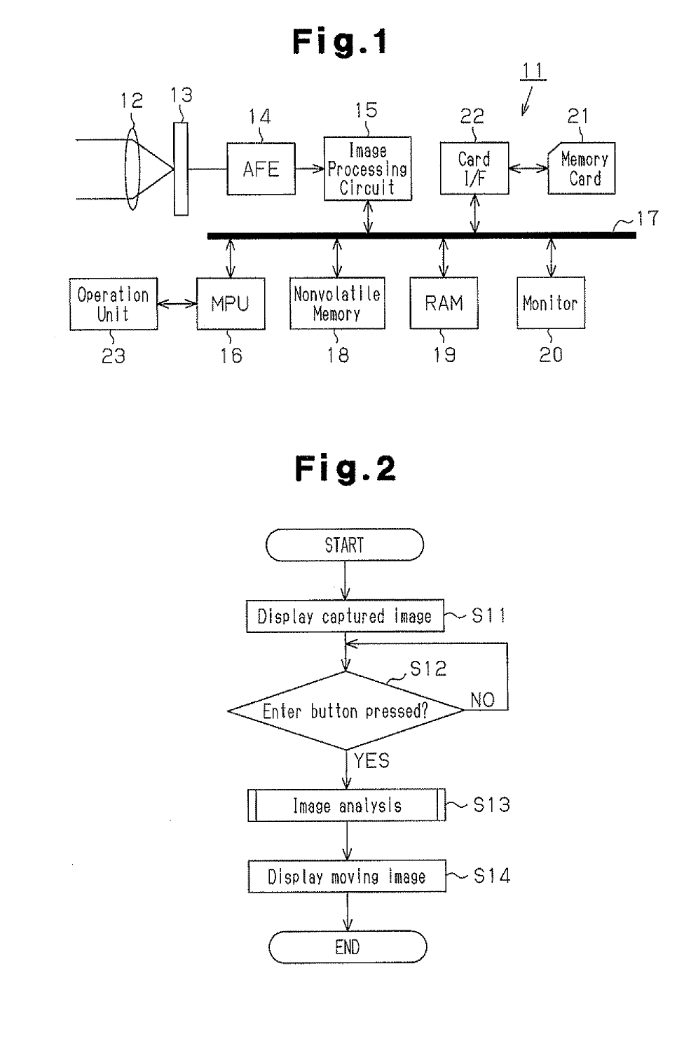

A digital still camera (hereafter referred to as a “camera”) according to a first embodiment of the present invention will now be described with reference to FIGS. 1 to FIG. 6(d).

As shown in FIG. 1, the camera 11 includes a lens unit 12 and an imaging element 13. The lens unit 12 includes a plurality of lenses (only one lens is shown in FIG. 1 to facilitates illustration), such as a zoom lens. The imaging element 13 receives captured subject light transmitted through the lens unit 12. An analog front end (AFE) 14 and an image processing circuit 15 are connected to the imaging element 13. A micro-processing unit (MPU) 16 is connected to the image processing circuit 15 via a data bus 17 and controls the image processing circuit 15.

A nonvolatile memory 18, a RAM 19, a monitor 20, and a card interface (I/F) 22 are connected to the MPU 16 via the data bus 17. The nonvolatile memory 18 stores control programs for controlling the camera 11. The RAM 19 functions as a buffer memory. The monitor 20 uses a liquid crystal display. A memory card 21, which is a recording medium, can be inserted into and removed from the card interface (I/F) 22. The MPU 16 can transmit and receive data to and from an operation unit 23, which is operated by a user of the camera 11. The operation unit 23 includes a mode switching button, a shutter button, a select button, and an enter button.

The imaging element 13 is formed by a complementary metal oxide semiconductor (CMOS) image sensor or a charge coupled device (CCD) image sensor. The imaging element 13 includes an image capturing plane at its incident side, on which a two-dimensional array of light-receiving elements (not shown) is arranged. The imaging element 13 accumulates signal charge corresponding to a subject image formed on the image capturing plane. Then, the imaging element 13 provides the AFE 14 with the accumulated signal charge as an analog signal referred to as a pixel signal, which forms image data.

The AFE 14 includes a signal processing unit and an A/D conversion unit (both not shown). The signal processing unit samples, at a predetermined timing, a pixel signal or an analog signal provided from the imaging element 13 (through correlated double sampling). Then, the signal processing unit amplifies the sampled signal to a predetermined signal level, which is based on the ISO speed. The A/D conversion unit converts the amplified pixel signal to a digital signal. The AFE 14 provides the image processing circuit 15 with image data generated by converting the analog pixel signal to a digital signal with the A/D conversion unit.

The image processing circuit 15 performs various types of image processing on the image data provided from the AFE 14. Then, the image processing circuit 15 temporarily stores the processed image data in the RAM 19 and displays the processed image data as a through-the-lens image) on the monitor 20. When the shutter button is fully pressed, the image processing circuit 15 displays an image formed by the currently captured image data on the monitor 20 so that it can be checked by the user. The image processing circuit 15 also stores the image data to the memory card 21 in an image file after performing predetermined image processing such as the formatting for JPEG compression on the image data.

The MPU 16 centrally controls the various types of image processing performed by the camera 11 based on image processing programs stored in the nonvolatile memory 18. The MPU 16 executes controls using the data bus 17 as a path for transmitting various types of data. The mode switching button of the operation unit 23 is operated to switch the operating modes of the camera 11 between, for example, a shooting mode and a reproduction mode. The shutter button is pressed to capture an image of a subject in the shooting mode. The select button is operated to switch the displayed reproduced images. The enter button is operated, for example, when setting the image subject to a special effect process of superimposing a moving image (a moving image superimposing process).

When the shutter button is pressed halfway, the camera 11 performs auto focusing to focus on a subject and auto exposure to adjust the exposure. When the shutter button is then fully pressed, the camera 11 forms a captured image and performs various types of image processing on the captured image.

The outline of a moving image superimposing routine performed by the MPU 16 when the camera 11 captures an image will now be described with reference to the flowchart shown in FIG. 2.

A power button (not shown) is pressed to activate the camera 11. In the activated state, when the mode switching button of the operation unit 23 is pressed to switch the operating mode to the reproduction mode, the MPU 16 starts the moving image superimposing routine shown in FIG. 2. In step S11, the MPU 16 reads an image file stored in the memory card 21 and reproduces, or displays, an image corresponding to the image data of the read image file on the monitor 20.

When the image is reproduced, or displayed, on the monitor 20, in step S12, the MPU 16 determines whether or not an image that is to undergo the moving image superimposing process has been determined. For example, the MPU 16 determines whether an image that is to undergo the moving image superimposing process has been determined based on whether or not the enter button of the operation unit 23 has been pressed. When such an image has not yet been determined (NO in step S12), the MPU 16 cyclically repeats the process of step S12 until such an image is determined. When such an image that is to undergo the moving image superimposing process has been determined (YES in step S12), the MPU 16 proceeds to step S13.

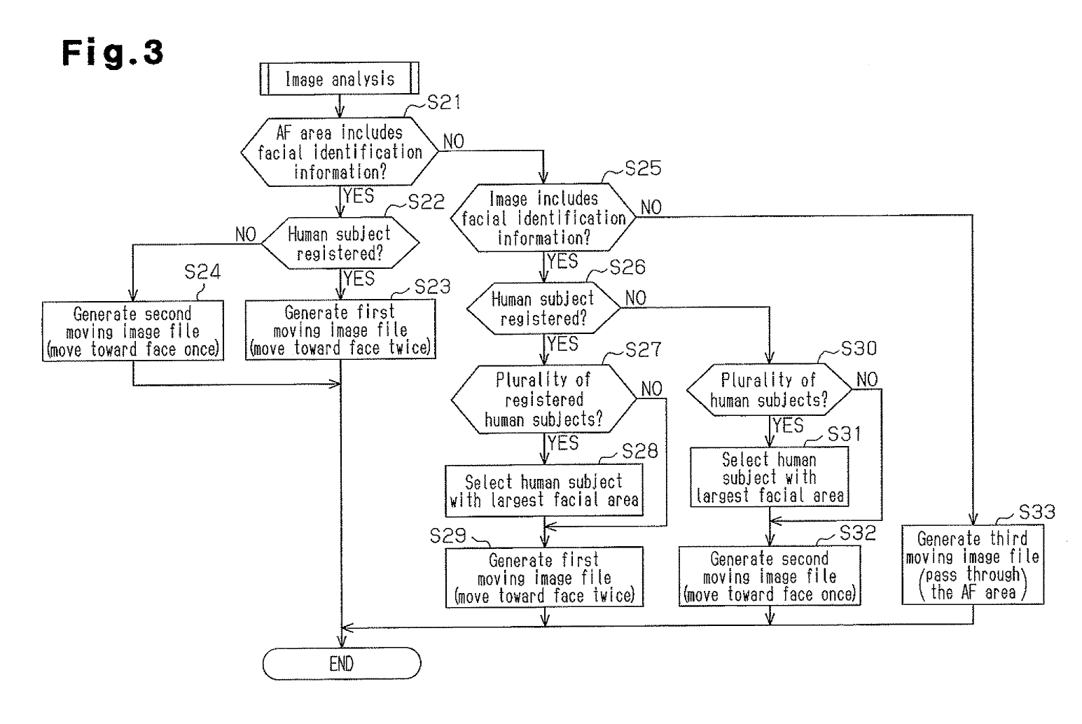

In step S13, the MPU 16 performs an image analysis routine shown in FIG. 3 on the image data read from the memory card 21. In the image analysis routine, the MPU 16 instructs the image processing circuit 15 to generate a moving image file associated with an image file of the image that is currently displayed on the monitor 20. The MPU 16 temporarily stores the moving image data generated in step S13 in the RAM 19, which functions as a buffer memory, and then proceeds to step S14.

In step S14, the MPU 16 reads the image file storing the image that has been determined in step S12 as the image that is to undergo the moving image superimposing process. Then, the MPU 16 provides the read image file to the monitor 20.

The MPU 16 further reads the moving image file generated in step S13 from the RAM 19 and provides the read moving image file to the monitor 20. As a result, the moving image is displayed on the monitor 20 superimposed on the image that is currently reproduced and displayed.

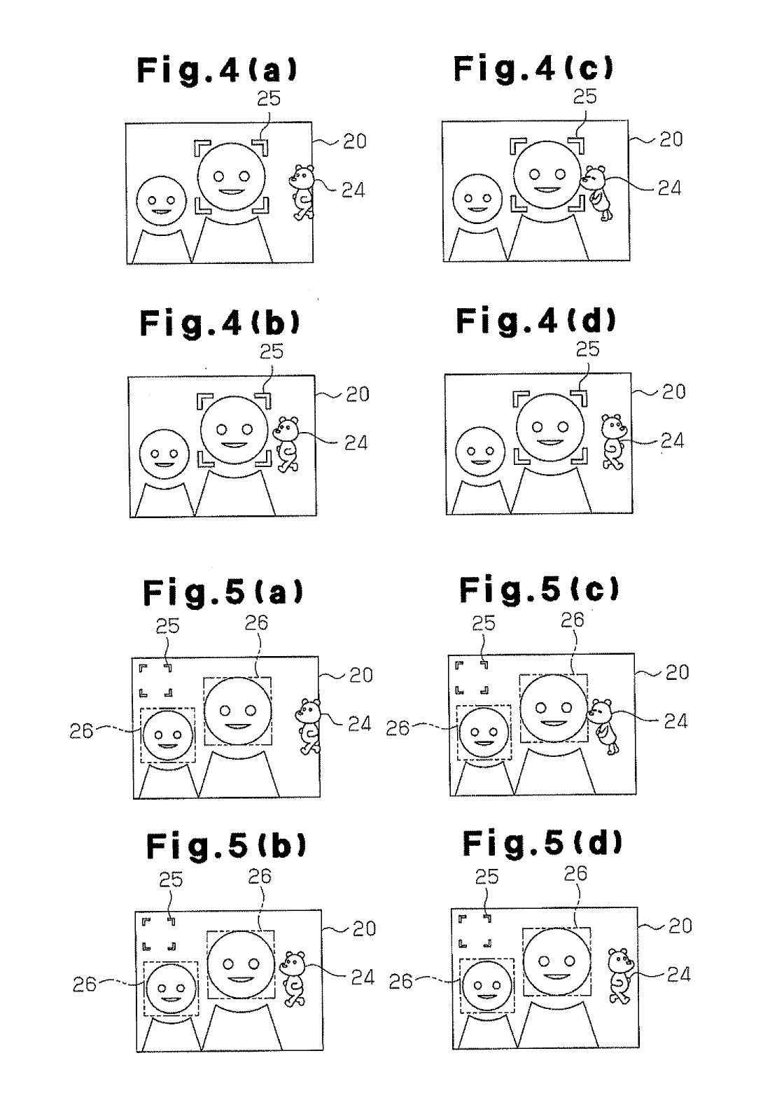

The image analysis routine performed by the MPU 16 in step S13 during the moving image superimposing routine will now be described with reference to FIG. 3. In the present embodiment, the moving image superimposed on the currently reproduced image may be a cartoon character 24, which functions as a moving object (refer to FIG. 4(a)). The user may select the moving object in advance from a plurality of moving objects stored in the camera 11, for example, before the MPU 16 starts the image analysis routine.

When the image analysis routine is started, in step S21, the MPU 16 first obtains information on the position of an AF area 25 in the image currently displayed on the monitor 20 (refer to FIG. 4(a)). The AF area 25 is the area in which focusing is performed and is an example of a feature of the image. The MPU 16 temporarily stores the obtained position information of the AF area 25 in the RAM 19. The position information of the AF area 25 may be referred to as an information element in image analysis information for the feature of an image. In one example of image analysis for a feature, the MPU 16 analyzes the AF area 25 and determines whether or not the AF area 25 includes the facial section of a human subject. More specifically, the MPU 16 analyzes the AF area 25 in the image and determines whether or not the AF area 25 includes the face of a human subject. When determining that the AF area 25 includes the face of a human subject (YES in step S21), the MPU 16 proceeds to step S22.

In step S22, as one example of image analysis for a feature, the MPU 16 performs a human subject determination process on the human subject in the AF area 25. More specifically, the MPU 16 analyzes facial information of the human subject in the AF area 25. The MPU 16 reads the facial information of each human subject registered in advance from a database of the nonvolatile memory 18. The MPU 16 then compares the facial information of the human subject in the AF area 25 with each the read registered facial information of each human subject and determines whether or not the human subject in the AF area 25 conforms to any of the registered human subjects.

When determining that the human subject in the AF area 25 conforms to a registered human subject (YES in step S22), the MPU 16 proceeds to step S23. In step S23, the MPU 16 selects, from a plurality of features included in the image, the AF area 25 as a feature given priority when a moving image is generated. The MPU 16 further acquires the position information of the AF area 25 from the RAM 19 as the image analysis information of the feature. This step functions as an acquisition step. In step S23, the MPU 16 generates a first moving image file based on the position information of the AF area 25. This step functions as a moving image generation step. More specifically, when the first moving image file is generated in step S23, the moving image superimposing routine of step S14 is performed to superimpose a moving image, which will be described below, on the image currently displayed on the monitor 20.

As shown in FIG. 4(a), the cartoon character 24, which faces to the left, first appears on the monitor 20 in a peripheral portion of the image horizontally rightward from the AF area 25. As shown in FIG. 4(b), the cartoon character 24 continuously moves to the left in the horizontal direction toward the AF area 25 while maintaining a left-facing posture. As shown in FIG. 4(c), when the cartoon character 24 reaches the AF area 25, the cartoon character 24 moves its face twice to the position of the human subject's face in the AF area 25. Subsequently, as shown in FIG. 4(d), the cartoon character 24 continuously moves away from the AF area 25 after switching to a right-facing posture and disappears from the monitor 20.

In step S23, the MPU 16 sets the path in which the cartoon character 24 moves so that the cartoon character 24 goes back and forth between the peripheral portion of the image and the AF area 25. When the cartoon character 24 moves its face to the position of the human subject's face in the AF area 25, the face of the cartoon character 24 is displayed partially superimposed in the AF area 25. In other words, the path in which the cartoon character 24 moves is set so that the cartoon character 24 passes by the AF area 25 of the image. This emphasizes the AF area 25 including the feature so that the user recognizes the emphasized feature.

When the human subject shown in the AF area 25 does not conform to any registered human subject (NO in step S22), the MPU 16 proceeds to step S24. In step S24, the MPU 16 selects, from a plurality of features included in the image, the AF area 25 as a feature given priority when a moving image is generated. Further, the MPU 16 obtains the position information of the AF area 25 from the RAM 19 as the image analysis information of the feature. This step functions as an acquisition step. In step S24, the MPU 16 generates a second moving image file based on the position information of the AF area 25. This step functions as a moving image generation step.

The second moving image file generated in step S24 differs from the first moving image file generated in step S23 in the movement of the cartoon character 24. Although the cartoon character 24 is the same in the first and second image files in that the movement path is set so that the cartoon character 24 goes back and forth between the peripheral portion of the image and the AF area 25, the action of the cartoon character 24 differs between the first and second image files in that the cartoon character 24 in the second moving image file moves its face only once to the position of the human subject's face in the AF area when the cartoon character 24 reaches the AF area 25.

When determining that the AF area 25 does not include a human subject in step S21 (NO in step S21), that is, when an object other than a human subject is being focused, the MPU 16 proceeds to step S25. In step S25, as one example of image analysis for a feature, the MPU 16 analyzes the image currently displayed on the monitor 20 and determines whether the image includes a facial area 26 of a human subject (refer to FIG. 5(a)). When determining that the image includes a human subject in step S25 (YES in step S25), the MPU 16 temporarily stores position information associated with the facial area 26 of the human subject in the RAM 19 as an information element of image analysis information associated with a feature of the image. Then, the MPU 16 proceeds to step S26.

In step S26, the MPU 16 performs the same human subject determination process as in step S22. More specifically, the MPU 16 compares facial information of the human subject in the image with the facial information of each registered human subject to determine whether the human subject in the image conforms to any registered human subject.

When determining that the human subject in the image conforms to a registered human subject (YES in step S26), the MPU 16 proceeds to step S27. In step S27, the MPU 16 determines whether or not a plurality of human subjects in the image conforms to human subjects that are registered in advance.

When determining that a plurality of human subjects in the image conform to human subjects registered in advance (YES in step S27), the MPU 16 proceeds to step S28. In step S28, as one example of image analysis for a feature, the MPU 16 calculates the size of the facial area 26 of each human subject of which facial information conforms to registered facial information (refer to FIG. 5(a)). The calculated size is an example of image analysis information of a feature. The MPU 16 compares the calculated sizes of the facial areas 26. The MPU 16 sets the human subject of which facial information indicating the largest size as a main subject. Then, the MPU 16 proceeds to step S29.

When determining in step S26 that the facial information conforms to the facial information of a registered human subject, the MPU 16 proceeds to step S27. In step S27, when determining that the facial information conforms to only one registered human subject (NO in step S27), the MPU 16 sets the human subject having the facial information conforming to the registered facial information as a main subject. Then, the MPU 16 proceeds to step S29.

In step S29, the MPU 16 selects, from a plurality of features included in the image, the facial area of the main subject as the feature given priority when a moving image is generated. The MPU 16 also reads the position information associated with the facial area of the main subject from the RAM 19. This step functions as an acquisition step. The position information associated with the facial area of the main subject is an example of an information element of the image analysis information. In step S29, the MPU 16 generates a first moving image file based on the position information associated with the facial area of the main subject obtained from the RAM 19. This step functions as a moving image generation step. More specifically, when the first moving image file is generated in step S29, the moving image superimposing routine of step S14 is performed to superimpose a moving image, which will be described below, on the image currently displayed on the monitor 20.

As shown in FIG. 5(a), the cartoon character 24, which faces to the left, first appears at a peripheral portion of the image in the monitor 20 horizontally rightward from the facial area 26 of the human subject set as the main subject. As shown in FIG. 5(b), the cartoon character 24 continuously moves to the left in the horizontal direction toward the facial area 26 of the main subject while maintaining a left-facing posture. As shown in FIG. 5(c), when the cartoon character 24 reaches the facial area 26 of the main subject, the cartoon character 24 moves its face twice to the position of the main subject's face. Subsequently, as shown in FIG. 5(d), the cartoon character 24 continuously moves away from the facial area 26 of the main subject after switching to a right-facing posture and disappears from the monitor 20.

In step S29, the MPU 16 sets the path in which the cartoon character 24 moves so that the cartoon character 24 goes back and forth between the peripheral portion of the image of the cartoon character 24 and the facial area 26 of the main subject. More specifically, in step S29, the MPU 16 selects the facial area 26 of the main subject from a plurality of facial areas of human subjects determined as features of the image. Then, the MPU 16 sets the path in which the cartoon character 24 moves to include the position indicated by the position information of the selected facial area 26.

When the human subject in the image does not conform to any human subject registered in step S26 (NO in step S26), the MPU 16 proceeds to step S30. In step S30, the MPU 16 determines whether the facial information of a plurality of human subjects has been obtained in step S25.

When determining that the facial information obtained in step S25 is for a plurality of human subjects (YES in step S30), the MPU 16 proceeds to step S31. In step S31, the MPU 16 sets the human subject of which facial information indicates the facial area 26 having the largest size in the same manner as in step S28. Then, the MPU 16 proceeds to step S32.

When determining in step S30 that the facial information obtained in step S25 is for only one human subject, the MPU 16 sets the human subject associated with the facial information obtained in step S25 as a main subject. Then, the MPU 16 proceeds to step S32.

In step S32, the MPU 16 selects, from a plurality of features included in the image, the facial area of the main subject as the feature given priority when a moving image is generated. Further, the MPU 16 obtains the position information associated with the facial area of the main subject from the RAM 19 as an information element of the image analysis information of the feature. This step functions as an acquisition step. In step S32, the MPU 16 generates a second moving image file based on the position information associated with the facial area of the main subject obtained from the RAM 19. This step functions as a moving image generation step. The second moving image file generated in step S32 differs from the first moving image file generated in step S29 in the action of the cartoon character 24. Although the cartoon character 24 is the same in the first and second image files in that the path in which the cartoon character 24 moves is set so that the cartoon character 24 goes back and forth between the peripheral portion of the image and the facial area 26 of the main subject, the action of the cartoon character 24 differs between the first and second image files in that the cartoon character 24 in the second moving image file moves its face only once to the facial position of the main subject when the cartoon character 24 reaches the facial area 26 of the main subject.

When determining that the image displayed on the monitor 20 does not include a human subject in step S25 (NO in step S25), the MPU 16 proceeds to step S33. In step S33, the MPU 16 selects, from a plurality of features included in the image, the AF area 25 as a feature given priority when a moving image is generated. The MPU 16 also reads the position information of the AF area 25 from the RAM 19 as an information element of the image analysis information of the feature. This step functions as an acquisition step. In step S33, the MPU 16 generates a third moving image file based on the position information of the AF area 25 obtained from the RAM 19. This step functions as a moving image generation step. More specifically, when the third moving image file is generated in step S33, the moving image superimposing routine of step S14 is performed to superimpose a moving image, which will be described below, on the image currently displayed on the monitor 20.

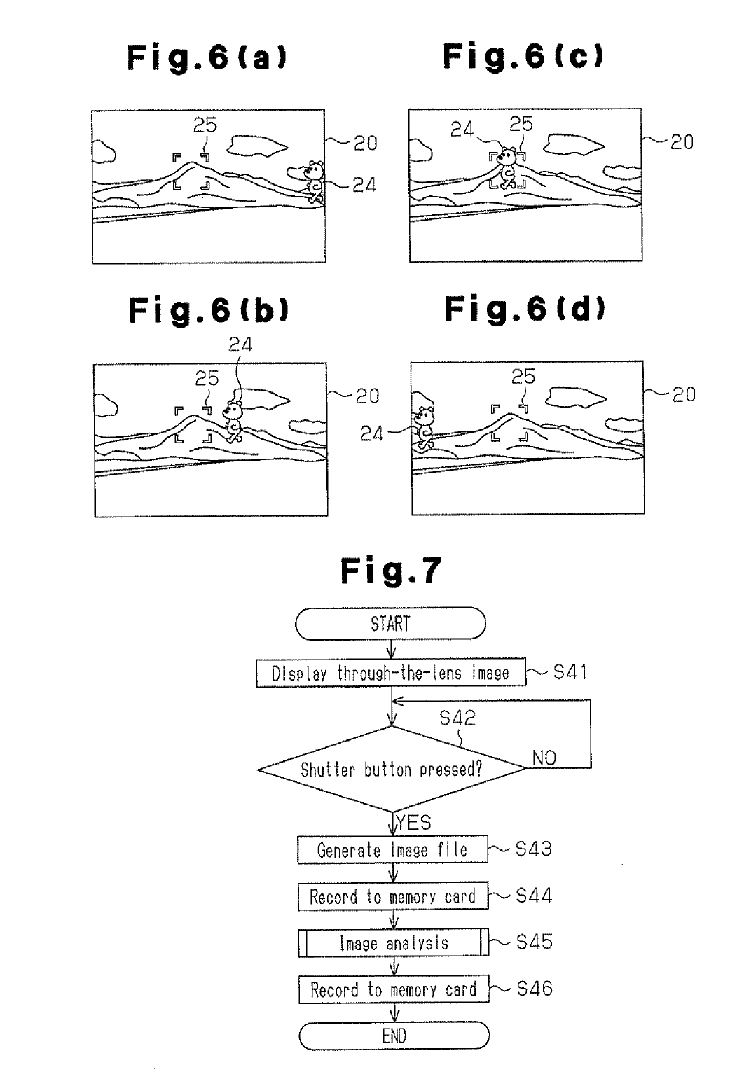

As shown in FIG. 6(a), the cartoon character 24, which faces to the left, first appears at a peripheral portion of the image of the monitor 20 horizontally rightward from the AF area 25. As shown in FIG. 6(b), the cartoon character 24 continuously moves to the left in the horizontal direction toward the AF area 25 while maintaining a left-facing posture. As shown in FIG. 6(c), when the cartoon character 24 reaches the AF area 25, the cartoon character 24 continues to move to the left in the horizontal direction to pass through the middle of the AF area 25. Subsequently, as shown in FIG. 6(d), the cartoon character 24 moves away from the AF area 25 to the left in the horizontal direction and disappears from the monitor 20.

When completing the moving image file generation process in any of steps S23, S24, S29, and S33, the MPU 16 ends the image analysis routine.

In the present embodiment, when the type of the cartoon character 24 displayed as the moving image changes, the processing performed in the moving image superimposing routine changes. More specifically, a change in the type of the cartoon character 24 changes the information element selected from the plurality of information elements obtained as the image analysis information associated with the feature of an image and given priority when a moving image is generated. This enables the MPU 16 to perform a special effect process using a variety of superimposed moving images on an image.

In the illustrated embodiment, the MPU 16 functions as an acquisition unit, a moving image generation unit and a reproduction unit. In the above-illustrated example, a group of electronic circuits including at least the MPU 16 may be referred to as an image processor. The path in which the cartoon character 24 moves and the face movement of the cartoon character 24 are examples of a pattern (a display pattern) of a moving image.

The first embodiment has the advantages described below.

(1) The image processor displays a moving image in a pattern that changes in accordance with the image analysis information of a feature included in an image. The image processor changes the display pattern of the moving image in a variety of manners in accordance with image analysis information of a feature included in an image. This allows for a wide variety of special effects using a moving image to be added to images of different image contents.

(2) Even when a plurality of features is included in a single image, the image processor selects the feature given priority in accordance with the image analysis information of the features. This adds a special effect using a moving image to emphasize at least one feature selected from the plurality of features.

(3) In accordance with the type of the cartoon character 24 generated and displayed as a moving image, the image processor selects, from a plurality of information elements obtained as the image analysis information of the features included in an image, the information element that is given priority. As a result, the image processor changes the pattern of the moving image special effect added to the image in accordance with the type of the cartoon character 24 displayed as the moving image. This adds a wider variety of moving image special effects to an image.

(4) The image processor changes the path in which the cartoon character 24 superimposed on the image moves in a variety of manners in accordance with position information associated with a feature included in the image. This adds a wide variety of moving image special effects on an image even when using the same cartoon character 24.

(5) When an image includes a facial area 26 of a human subject, the image processor sets the path in which the cartoon character 24 moves so that the cartoon character 24 passes by the facial area 26 of the human subject. This adds a special effect using a moving image that emphasizes the facial area 26 of the human subject.

(6) When an image includes a plurality of facial areas 26 of human subjects, the image processor selects the facial area 26 of the main subject from the plurality of facial areas 26. The image processor then sets the path in which the cartoon character 24 moves to include the position indicated by the position information associated with the selected facial area 26.

(7) When an image includes a plurality of facial areas 26 as features, the image processor selects a specific facial area 26 from the plurality of facial areas 26 based on an analysis result of the image information of the plurality of facial areas 26. Then, the image processor sets the path in which the cartoon character 24 moves to include the selected facial area 26.

(8) The image processor uses, as the analysis information used to set the path in which the cartoon character 24 moves, the size of each facial area 26 among a plurality of elements of the image analysis information on the plurality of facial areas 26 included in an image. When the image includes a plurality of facial areas 26, the image processor selects the facial area of the main subject from the plurality of facial areas 26 and sets the path in which the cartoon character 24 moves to include the position indicated by the position information associated with the facial area 26 of the selected main subject.

(9) The image processor changes the motion of the cartoon character 24 based on whether or not the human subject in the image is identified as a human subject registered in the database. Thus, the image processor changes the movement of the cartoon character 24 superimposed on the image in a variety of patterns in accordance with the information on the human subject registered in the electronic camera 11. This enables a wide variety of moving image special effects to be added to different images.

(10) The image processor eliminates the need for generating a moving image file before reproducing an image.

Thus, unnecessary moving image files are not generated. This improves the operability of the camera 11 and prevents unnecessary processing load from being applied to the MPU 16.

### Second Embodiment

A second embodiment of the present invention will now be discussed. The second embodiment differs from the first embodiment only in that the image analysis shown in FIG. 2 is performed when an image is captured. The difference from the first embodiment will be described below. Parts that are the same as the first embodiment will not be described.

In a state in which the power button (not shown) of the camera 11 is switched on, the MPU 16 starts the imaging routine shown in FIG. 7 when the mode switching button of the operation unit 23 is switched to the shooting mode. In step S41, the MPU 16 first displays, on the monitor 20, a through-the-lens image corresponding to image data provided to the image processing circuit 15 from the imaging element 13 via the AFE 14. In step S42, the MPU 16 determines whether the shutter button of the operation unit 23 has been pressed while continuously displaying the through-the-lens image.

When a negative determination is made in step S42, the MPU 16 cyclically repeats the process of step S42 until the shutter button is pressed. When an affirmative determination is given in step S42, the MPU 16 proceeds to step S43.

In step S43, the MPU 16 instructs the image processing circuit 15 to generate an image file that stores image data of a captured image including additional information while continuously displaying the captured image. In step S44, the MPU 16 records the image file onto the memory card 21 that is inserted in the card I/F 22.

In step S45, the MPU 16 generates a moving image file by performing the same processing as the image analysis routine shown in FIG. 3. In the image analysis routine, the MPU 16 instructs the image processing circuit 15 to generate a moving image file that stores additional information associating the image file of the captured image with the image data of the moving image. Then, in step S47, the MPU 16 records the generated moving image file to the memory card 21 that is inserted in the card I/F 22. When the process of step S46 is completed, the MPU 16 ends the imaging routine.

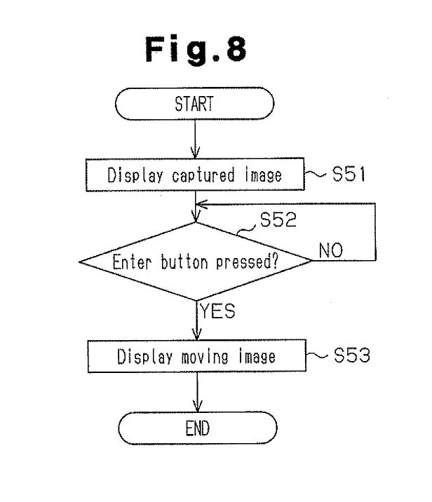

In a state in which the power button (not shown) of the camera 11 is switched, when the mode switching button of the operation unit 23 is switched to the reproduction mode, the MPU 16 starts the moving image superimposing routine shown in FIG. 8.

The MPU 16 proceeds to step S51 and then to step S52 to read the image file of the captured image that is to undergo the moving image superimposing process. In step S53, the MPU 16 analyzes the additional information added to the moving image file recorded in the memory card 21. Then, the MPU 16 reads the moving image file associated with the image file of the captured image that is to undergo the moving image superimposing process and provides the read moving image file to the monitor 20. As a result, the moving image corresponding to the captured image is displayed on the monitor 20 superimposed on the captured image. After completing the processing in step S53, the MPU 16 ends the moving image superimposing routine.

The second embodiment of the present invention has the advantage described below in addition to advantages (1) to (7) of the first embodiment.

(11) The image processor generates a moving image file in advance before a captured image is reproduced and displayed. This prevents a large processing load from being applied to the MPU 16 even when the MPU 16 superimposes a complicated moving image on a captured image.

### Third Embodiment

A third embodiment of the present invention will now be discussed. The third embodiment differs from the first embodiment only in that a first image analysis routine and a second image analysis routine are performed when a moving image file is generated. The difference from the first embodiment will be described below. Parts that are the same as the first embodiment will not be described.

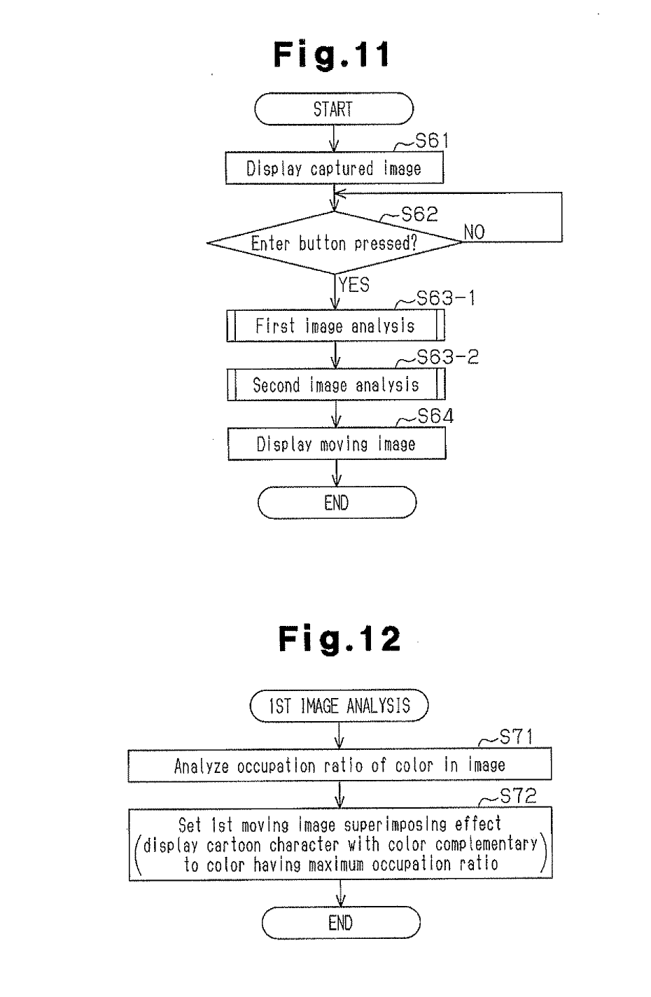

As shown in FIG. 11, the MPU 16 performs the processes of steps S61 and S62 that are similar to the processes of steps S11 and S12 shown in FIG. 2. Then, in step S63-1, the MPU 16 performs a first image analysis routine shown in FIG. 12 on the image data that has been read from the memory card 21. When performing the first image analysis routine in step S63-1, the MPU 16 determines the type (display form) of cartoon character that is to be superimposed on the image currently displayed on the monitor 20.

In step S63-2, the MPU 16 performs a second image analysis routine on the image data. The second image analysis routine is similar to the image analysis routine shown in FIG. 3. When the second image analysis routine is performed in step S63-2, the MPU 16 instructs the image processing circuit 15 to generate a moving image file associated with the image file of the image that is currently displayed on the monitor 20. Subsequently, the MPU 16 performs the process of step S64 that is similar to the process of S14 shown in FIG. 2 to display a moving image superimposed on the image currently reproduced on the monitor 20.

The first image analysis routine performed by the MPU 16 in step S63-1 during the moving image superimposing routine will now be described with reference to FIG. 12.

When the first image analysis routine is started, the MPU 16 first analyzes the occupation ratio of the colors included in the entire image currently displayed on the monitor 20 in step S71. The MPU 16 temporarily stores the color occupation ratio acquired through the image analysis in the RAM 19 and then proceeds to step S72.

In step S72, the MPU 16 reads the information related to the color occupation ratio acquired in step S71 from the RAM 19. Further, the MPU 16 sets a first moving image superimposing effect based on the read information related to the color occupation ratio. More specifically, the MPU 16 determines the color having the highest occupation ratio in the entire image based on the information related to the color occupation ratio read from the RAM 19. The MPU 16 further selects, as a moving object superimposed on the image, a cartoon character with a color having a complementary relation with the color of the largest occupation ratio. After the first moving image superimposing effect is set in step S72, a moving image that is described below is displayed on the monitor 20 in step S14 of the moving image superimposing routine and superimposed on the currently reproduced image.

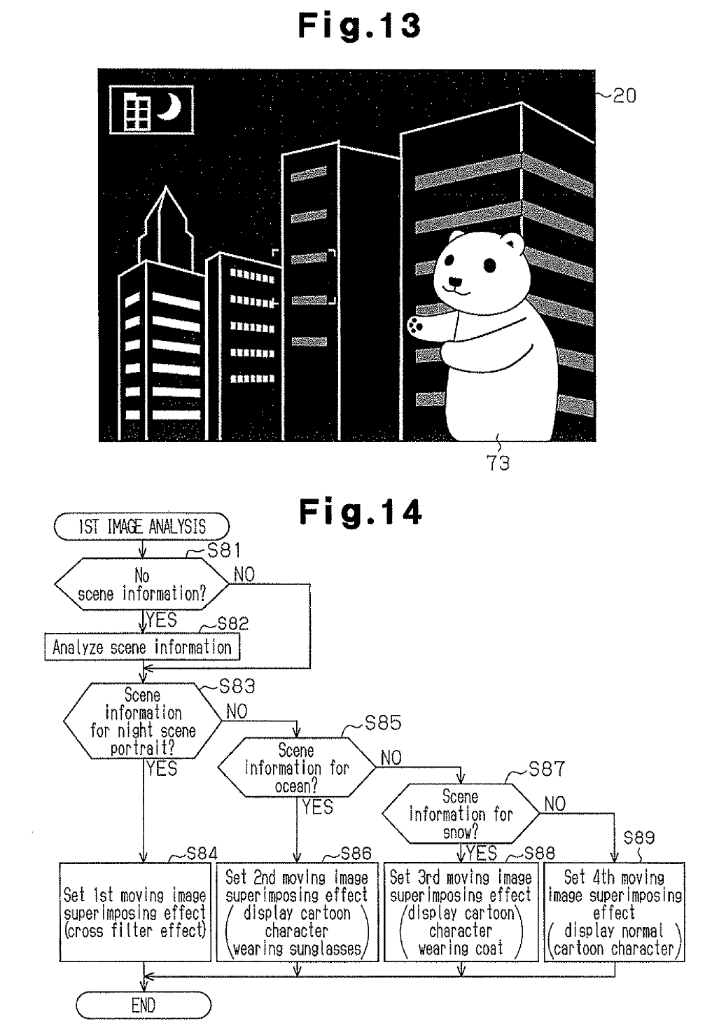

For instance, as shown in FIG. 13, when the background color of the entire image currently displayed on the monitor 20 is black, the color having the largest occupation ratio in the entire image is black. In this case, a white cartoon character 73, the color of which is complementary to black, is displayed on the monitor 20 horizontally rightward from the AF area in the horizontal direction. The color arrangement of the entire image results in the cartoon character 73 being displayed as a prominent moving image superimposed on the image that is currently displayed on the monitor 20.

The third embodiment has the advantages described below in addition to advantages (1) to (10) of the first embodiment.

(12) The moving image is displayed in a wide variety of appearances in accordance with the image analysis information (for example, the white cartoon character 73 is displayed). This allows for a special effect process that adds a variety of superimposed moving images in accordance with the contents of each image.

(13) The image processor changes the form of the cartoon character 73 displayed as a moving image in accordance with the color occupation ratio, which is an analysis information element of an image. Thus, a wide variety of special effects using superimposed moving images may be added to images of different color arrangements in accordance with the color arrangement of each image.

(14) The image processor displays, as a moving image, a cartoon character 73 having a color that is complementary to the color having the highest occupation ratio in the entire image. Such a color arrangement of the entire image results in the cartoon character 73 being displayed as a prominent image.

### Fourth Embodiment

A fourth embodiment of the present invention will now be described. The fourth embodiment differs from the third embodiment only in the processing contents of the first image analysis routine. The difference from the third embodiment will be described below. Parts that are the same as the third embodiment will not be described.

As shown in FIG. 14, when the first image analysis routine is started, in step S81, the MPU 16 first determines whether or not an image file that stores image data of an image currently displayed on the monitor 20 includes scene information indicating the shooting mode of the captured image. When determining that the image file includes no scene information (YES in step S81), the MPU 16 proceeds to step S82.

In step S82, the MPU 16 analyzes the image currently displayed on the monitor 20 to obtain scene information of the image. The MPU 16 stores the scene information in the image file as feature information of the image and then proceeds to step S83.

When determining that the image file includes scene information in step S81 (NO in step S81), the MPU 16 proceeds to step S83.

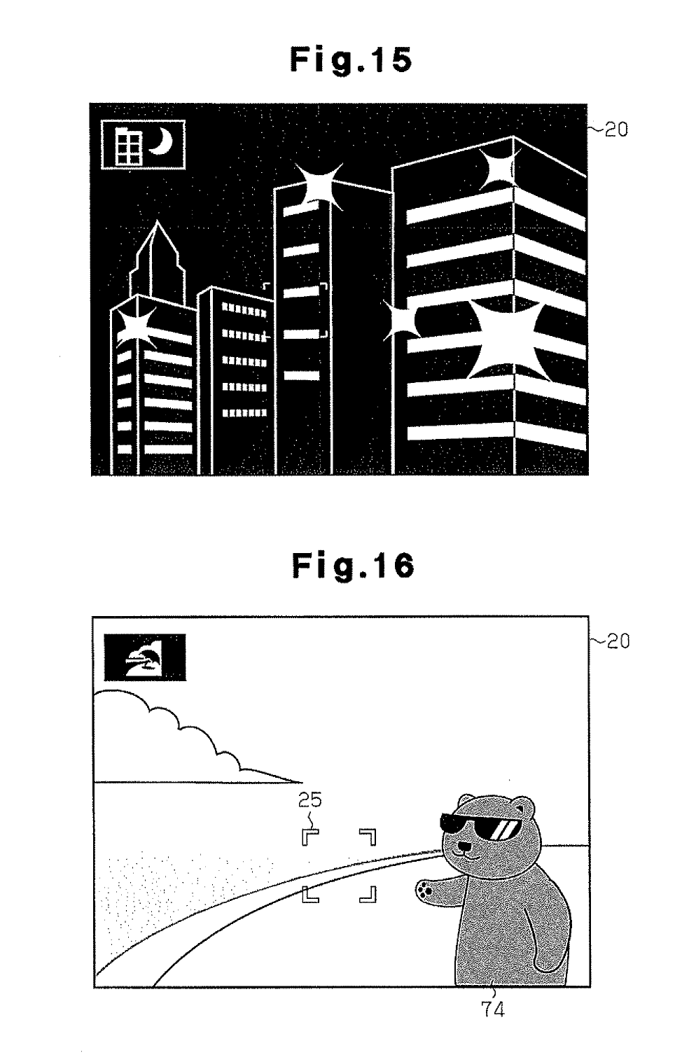

In step S83, the MPU 16 reads the scene information stored in the image file and then determines whether the read scene information indicates a “night scene portrait”. When determining that the read scene information indicates a “night scene portrait” (YES in step S83), the MPU 16 proceeds to step S84 to set a first moving image superimposing effect that corresponds to a night scene portrait as the moving image superimposing effect for the image. More specifically, the MPU 16 sets a special effect process using a cross screen filter to effectively decorate the image of a night scene as the first moving image superimposing effect. After the first moving image superimposing effect is set in step S84, a moving image shown in FIG. 15 is displayed on the monitor 20 in the step for displaying a moving image (hereafter corresponding to, for example, step S14 in FIG. 2 or step S64 in FIG. 11) of the moving image superimposing routine and superimposed on the image that is currently displayed. In the example shown in FIG. 15, a moving image of diffused light is superimposed on the image that is currently displayed on the monitor 20.

When a negative determination is given in step S83, the MPU 16 proceeds to step S85. In step S85, the MPU 16 determines whether the read scene information indicates an “ocean”. When determining that the read scene information indicates an “ocean” (YES in step S85), the MPU 16 proceeds to step S86 and sets a second moving image superimposing effect corresponding to the ocean as the moving image superimposing effect for the image. More specifically, the MPU 16 sets a cartoon character that effectively decorates an image of the ocean and functions as the moving object of the moving image. After the second moving image superimposing effect is set as the moving image superimposing effect for the image, the moving image shown in FIG. 16 is displayed on the monitor 20 in the moving image displaying step of the moving image superimposing routine and superimposed on the image that is currently displayed. For example, a cartoon character 74 wearing sunglasses is displayed horizontally rightward from the AF area 25 as the moving image superimposed on the image that is currently displayed on the monitor 20.

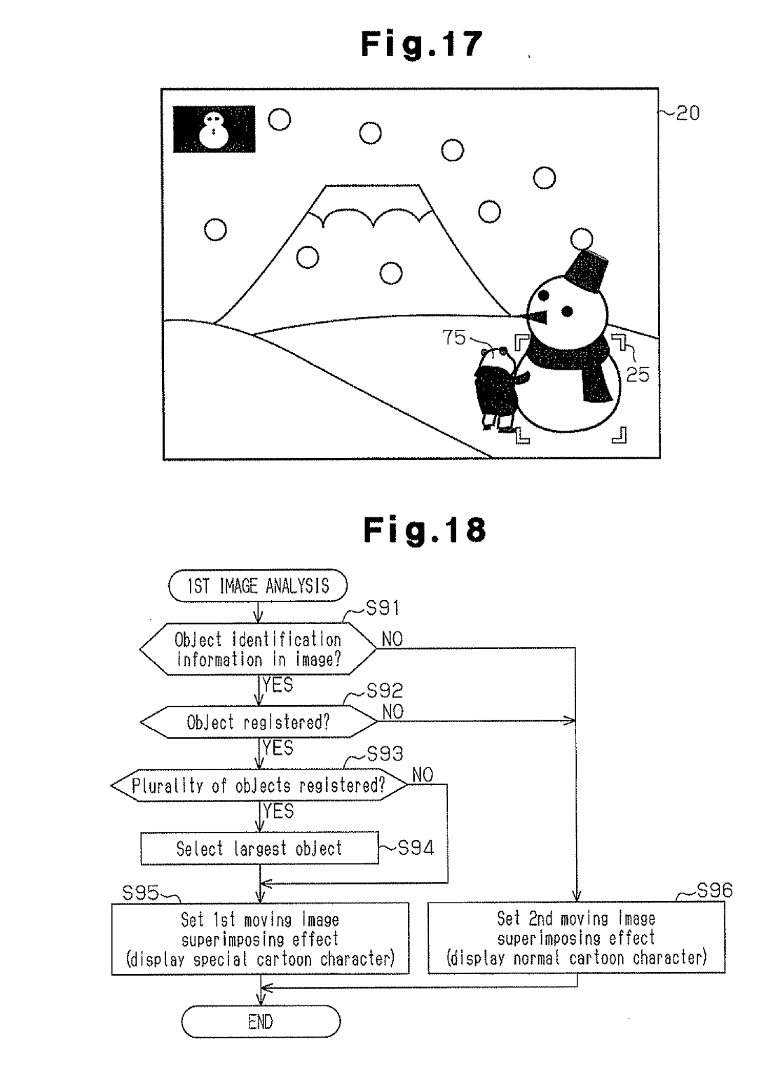

When determining that the read scene information does not indicate “ocean” (NO in step S85), the MPU 16 proceeds to step S87. In step S87, the MPU 16 determines whether the read scene information indicates “snow”. When the read scene information indicates “snow” (YES in step S87), the MPU 16 proceeds to step S88 sets a third moving image superimposing effect corresponding to snow as the moving image superimposing effect for the image. More specifically, the MPU 16 sets a cartoon character 75 that effectively decorates an image of snow and functions as the moving object of the moving image. After the third moving image superimposing effect is set in step S88, a moving image shown in FIG. 17 is displayed on the monitor 20 in the moving image displaying step of the moving image superimposing routine and superimposed on the image that is currently displayed. For example, a cartoon character 75 wearing a coat is displayed horizontally leftward from the AF area 25 as the moving image superimposed on the image that is currently displayed on the monitor 20.

When determining that the read scene information does not indicate “snow” in step S87 (NO in step S87), the MPU 16 proceeds to step S89. In step S89, the MPU 16 sets a fourth moving image superimposing effect, which is for normal images, for the image. After the fourth moving image superimposing effect is set in step S89, an image of a normal cartoon character is displayed on the monitor 20 in the moving image displaying step of the moving image superimposing routine and superimposed on the image that is currently displayed.

The fourth embodiment has the advantage described below in addition to advantages (1) to (10) described in the first embodiment and advantage (12) described in the third embodiment.

(15) The image processor changes the moving image special effect in accordance with the scene of a captured image. This allows for a special effect process that adds a variety of superimposed moving images in accordance with the captured scene of each image.

### Fifth Embodiment

A fifth embodiment of the present invention will now be discussed. The fifth embodiment differs from the third and fourth embodiments only in the processing of the first image analysis routine. The difference from the third and fourth embodiments will be described below. Parts that are the same as the third and fourth embodiments will not be described.

As shown in FIG. 18, when the first image analysis routine is started, in step S91, the MPU 16 first determines whether or not an image includes an object that may be used as a feature. This process is one example of an image analysis for a feature. More specifically, the MPU 16 analyzes the image currently displayed on the monitor 20 and determines whether the image includes an object. When determining that the image includes an object in step S91 (YES in step S91), the MPU 16 proceeds to step S92.

In step S92, the MPU 16 performs an object determination process, which is one example of an image analysis for a feature, on an object in the image. More specifically, the MPU 16 analyzes identification information of the object in the image. The identification information is an information element of image analysis information on the feature. The MPU 16 then temporarily stores the identification information in the RAM 19 and reads the identification information related with each object registered in advance in the database of the nonvolatile memory 18. The MPU 16 then compares the identification information of the object in the image with the read identification information of each object to determine whether the object in the image conforms to any of the registered objects.

When determining that the object in the image conforms to a registered object (YES in step S92), the MPU 16 proceeds to step S93. In step S93, the MPU 16 determines whether a plurality of objects in the image conforms to registered objects.

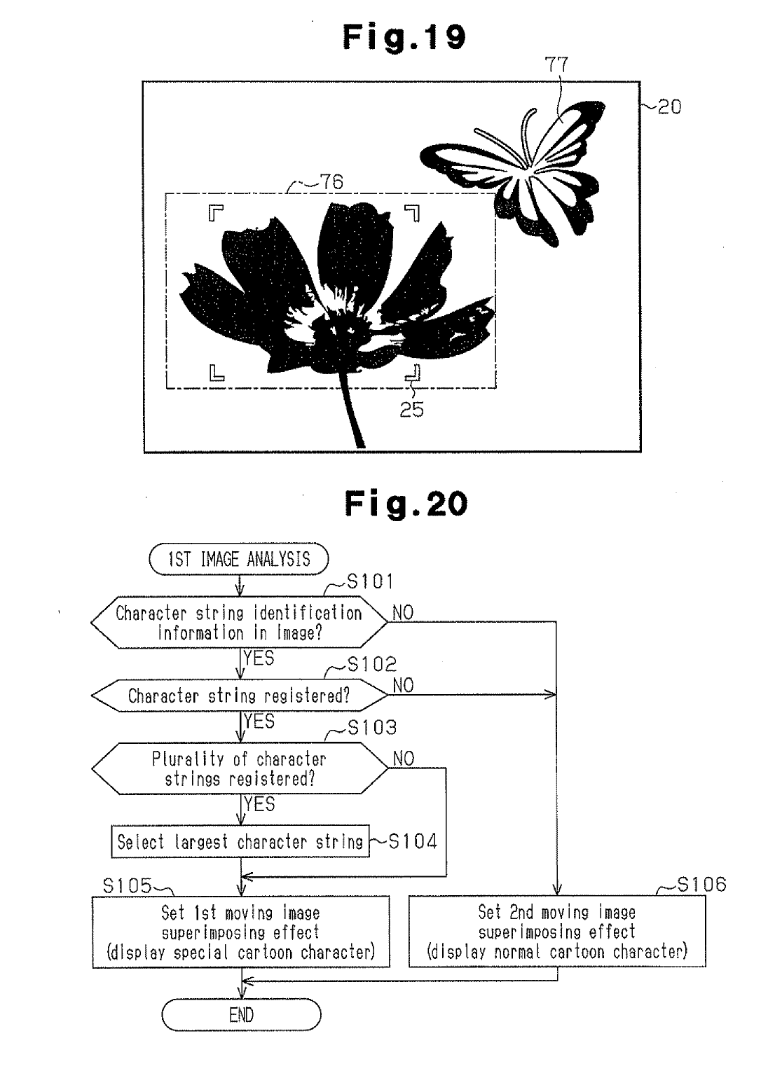

In step S93, when determining that a plurality of objects in the image conform to registered objects (YES in step S93), the MPU 16 proceeds to step S94. In step S94, as one example of an image analysis for a feature, the MPU 16 calculates the size of an object area 76 occupied by each object of which identification information conforms to the registered identification information (refer to FIG. 19). The calculated size is an example of image analysis information of a feature. The MPU 16 compares the calculated size of each object area 76 and sets the object having the largest object area 76 as a main subject. Then, the MPU 16 proceeds to step S95.

In step S93, when determining that the identification information of only one object conforms to the registered identification information (NO in step S93), the MPU 16 sets the object of which identification information conforms to the registered identification information as a main subject. Then, the MPU 16 proceeds to step S95.

In step S95, the MPU 16 sets a first moving image superimposing effect for the image based on the identification information, obtained from the RAM 19, of the object that is set as the main subject. More specifically, the MPU 16 selects a cartoon character that effectively decorates the main subject and functions as a moving object of a moving image. After the first moving image superimposing effect is set for the image in step S95, a moving image such as that shown in FIG. 19 is displayed on the monitor 20 in the moving image display step of the moving image superimposing routine. This superimposes the moving image on the currently displayed image. In the example shown in FIG. 19, a cartoon character 77 effectively decorates the image of a flower, which is the main subject in the AF area 25. The cartoon character 77 is displayed as a moving image that is superimposed on the image currently displayed on the monitor 20.

When determining that the image currently displayed on the monitor 20 does not include an object in step S91 (NO in step S91) or when determining that no object in the image conforms to a registered object (NO in step S92), the MPU 16 proceeds to step S96.

In step S96, the MPU 16 sets a second moving image superimposing effect, which is a moving image superimposing effect used for normal images, for the image. More specifically, the MPU 16 sets a normal cartoon character as a moving object of a moving image. After the second moving image superimposing effect is set for the image in step S96, an image of the normal cartoon character is displayed on the monitor 20 in the moving image display step of the moving image superimposing routine. This superimposes the moving image on the currently displayed image.

The fifth embodiment has the advantage described below in addition to advantages (1) to (10) of the first embodiment and advantage (12) of the third embodiment.

(16) The image processor changes the moving image superimposing effect in accordance with the type of object shown in an image. Thus, the image processor can add a wide variety of moving image superimposing effects on various images, each having different image contents.

### Sixth Embodiment

A sixth embodiment of the present invention will now be discussed. The sixth embodiment differs from the third to fifth embodiments only in the processing of the first image analysis routine. The difference from the third to fifth embodiments will be described below. Parts that are the same as the third to fifth embodiments will not be described.

As shown in FIG. 20, as one example of an image analysis for a feature, when the first image analysis routine is started, the MPU 16 first determines whether or not an image includes a string of characters that may be used as a feature. That is, the MPU 16 analyzes the image currently displayed on the monitor 20 and determines whether or not the image includes a character string. When determining that the image includes a character string in step S101 (YES in step S101), the MPU 16 proceeds to step S102.

In step S102, as one example of an image analysis for a feature, the MPU 16 performs a character string determination process on a character string. More specifically, the MPU 16 analyzes identification information of the character string in the image. The identification information is an information element of image analysis information on the feature. The MPU 16 then temporarily stores the identification information in the RAM 19 and reads the identification information of each character string registered in advance in the database of the nonvolatile memory 18. The MPU 16 then compares the identification information of the character string in the image with the read identification information of each registered character string to determine whether the character string in the image conforms to any registered character string.

When determining that the character string in the image conforms to a registered character string (YES in step S102), the MPU 16 proceeds to step S103. In step S103, the MPU 16 determines whether a plurality of character strings in the image conform to the registered character strings.

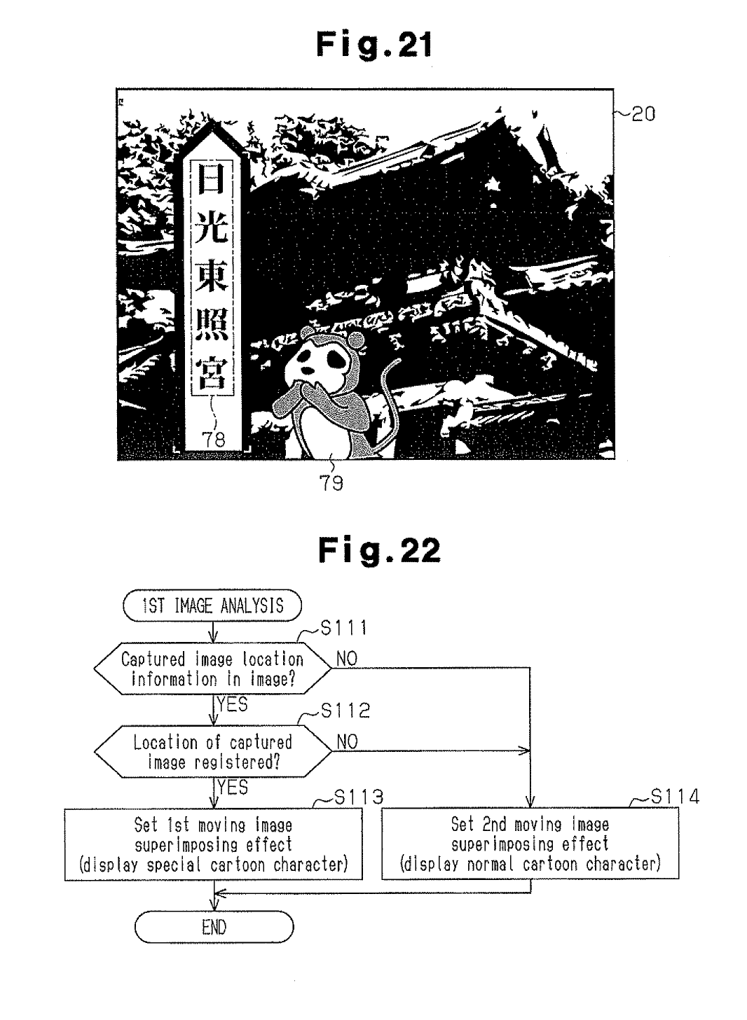

In step S103, when determining that a plurality of character strings in the image conform to registered character strings (YES in step S103), the MPU 16 proceeds to step S104. In step S104, as one image analysis example for a feature, the MPU 16 calculates the size of a string area 78 occupied by each character string of which identification information conforms to the identification information of a registered character string (refer to FIG. 21). The calculated size is an example of image analysis information of a feature. The MPU 16 compares the calculated size of each string area 78 and sets the character string having the largest string area 78 as a main subject. Then, the MPU 16 proceeds to step S105.

In step S103, when determining that the identification information of only one character string conforms to the registered identification information (NO in step S103), the MPU 16 sets the character string of which identification information conforms to the registered identification information as a main subject. Then, the MPU 16 proceeds to step S5104.

In step S104, the MPU 16 sets a first moving image superimposing effect for the image based on the identification information, obtained from the RAM 19, of the character string of the main subject. More specifically, the MPU 16 sets a cartoon character that effectively decorates the main subject as a moving object of a moving image. After the first moving image superimposing effect is set for the image in step S104, a moving image such as that shown in FIG. 21 is displayed on the monitor 20 in the moving image display step of the moving image superimposing routine. This superimposes the moving image on the currently displayed image. In the example shown in FIG. 21, the main subject in the AF area of the image currently displayed on the monitor 20 is the Japanese character string for Nikko Toshogu, which is a Japanese shrine that can be associated with monkeys. In this case, a cartoon character 79 of a monkey is superimposed as a moving image on the image.

When determining that the image currently displayed on the monitor 20 does not include a character string in step S101 (NO in step S101) or when determining that the image does not include a character string that conforms to a registered character string (NO in step S102), the MPU 16 proceeds to step S106.

In step S106, the MPU 16 sets a second moving image superimposing effect, which is a moving image superimposing effect used for normal images, for the image. More specifically, the MPU 16 sets a normal cartoon character as a moving object of a moving image. After the second moving image superimposing effect is set for the image in step S106, an image of the normal cartoon character is displayed on the monitor 20 in the moving image display step of the moving image superimposing routine. This superimposes the moving image on the currently displayed image.

The sixth embodiment has the advantage described below in addition to advantages (1) to (10) of the first embodiment and advantage (12) of the third embodiment.

(17) The image processor changes the moving image superimposing effect in accordance with the type of character string shown in an image. Thus, the image processor can add a wide variety of moving image superimposing effects on various images, each having different image contents.

### Seventh Embodiment

A seventh embodiment of the present invention will now be discussed. The seventh embodiment differs from the third to sixth embodiments only in the processing of the first image analysis routine. The difference from the third to sixth embodiments will be described below. Parts that are the same as the third to sixth embodiments will not be described.

As shown in FIG. 22, when the first image analysis routine is started, in step S111, the MPU 16 first determines whether metadata associated with the image that is currently displayed on the monitor 20 includes information of the location at which the image was captured.

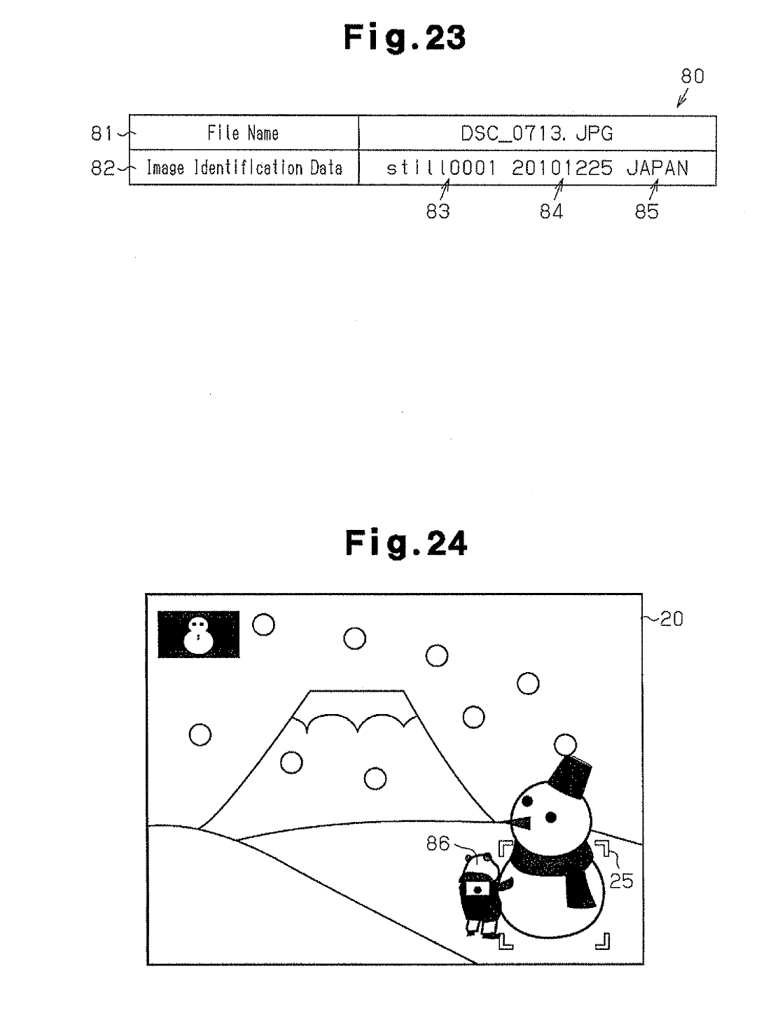

Metadata 80 that is associated with an image is generated when the image is captured and has the data structure shown in FIG. 23. The metadata 80 includes a file name 81 and image identification data 82. The image identification data 82 includes descriptions 83, 84, and 85. The description 83 (e.g., “still” or “movie”) indicates whether the corresponding image is a still image or a moving image. The description 84 (e.g., “20101225”) indicates information related to the date the image was captured. The description 85 (e.g., “Japan”) indicates information related to the location at which the image was captured.

The MPU 16 analyzes the metadata of the image displayed on the monitor 20 to determine whether the metadata includes the description 85 indicating information of the location at which the image was captured. When determining that the metadata of the image currently displayed on the monitor 20 includes captured image location information (YES in step S111), the MPU 16 proceeds to step S112.

In step S112, the MPU 16 first reads the information of each location registered in advance in the database of the nonvolatile memory 18. The MPU 16 then compares the captured image location information of the image that is currently displayed on the monitor 20 with the information of each registered location to determine whether the captured image location information of the image displayed on the monitor 20 conforms to the information of any registered location. When determining that the captured image location information of the image displayed on the monitor 20 conforms to the information of a registered location (YES in step S112), the MPU 16 proceeds to step S113.

In step S113, the MPU 16 sets a first moving image superimposing effect for the image based on the captured image location information of the image displayed on the monitor 20. More specifically, the MPU 16 sets a cartoon character that effectively emphasizes location at which the image was captured as a moving object of a moving image. After the first moving image superimposing effect is set for the image in step S113, a moving image such as that shown in FIG. 24 is displayed on the monitor 20 in the moving image display step of the moving image superimposing routine. This superimposes the moving image on the currently displayed image. In the example shown in FIG. 24, the location information of the image currently displayed on the monitor 20 indicates that the image was captured in Japan, which can be associated with the flag of the rising sun. In this case, a cartoon character 86 wearing a coat with the flag of the rising sun is superimposed as a moving image on the image.

When determining that the image currently displayed on the monitor 20 does not include captured image location information in step S111 (NO in step S111) or when determining that the captured image location information of the image currently displayed on the monitor 20 does not conform to the information of a registered location in step S112 (NO in step S112), the MPU 16 proceeds to step S114.

In step S114, the MPU 16 sets a second moving image superimposing effect, which is a moving image superimposing effect used for normal images, for the image. More specifically, the MPU 16 sets a normal cartoon character as a moving object of a moving image. After the second moving image superimposing effect is set for the image in step S114, an image of the normal cartoon character is displayed on the monitor 20 in the moving image display step of the moving image superimposing routine. This superimposes the moving image on the currently displayed image.

The seventh embodiment has the advantage described below in addition to advantages (1) to (10) of the first embodiment and advantage (12) of the third embodiment.

(18) The image processor changes the moving image superimposing effect in accordance with the location at which an image was captured. Thus, the image processor can add a wide variety of moving image superimposing effects on various images, each captured at a different location.

### Eighth Embodiment

An eighth embodiment of the present invention will now be discussed. The eighth embodiment differs from the seventh embodiment only in that the moving image superimposing effect is set based on the information of the date an image was captured in the metadata associated with the image. The difference from the seventh embodiment will be described below. Parts that are the same as the seventh embodiment will not be described.

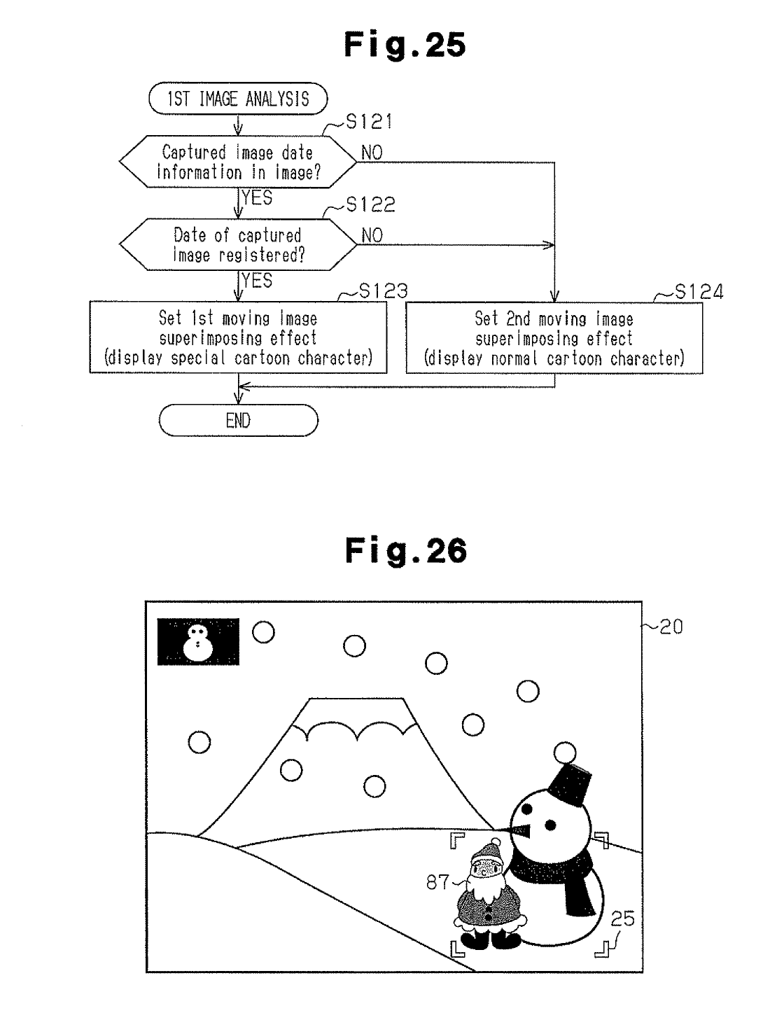

As shown in FIG. 25, when the first image analysis routine is started, in step S121, the MPU 16 first determines whether metadata associated with an image currently displayed on the monitor 20 includes a description 84 containing information about the date on which the image is captured (image capturing date information) and determines whether the metadata includes the image capturing date information. When determining that the metadata associated with the image currently displayed on the monitor 20 includes the image capturing date information of the image (YES in step S121), the MPU 16 proceeds to step S122.

In step S122, the MPU 16 reads information of dates, which are registered in advance, from the database of the nonvolatile memory 18. The MPU 16 then compares the information of the date on which the image currently displayed on the monitor 20 with the information of each registered date to determine whether the image capturing date of the image displayed on the monitor 20 conforms to any registered date. When determining that the image capturing date of the image currently displayed on the monitor 20 conforms to a registered date (YES in step S122), the MPU 16 proceeds to step S123.

In step S123, the MPU 16 sets the first moving image superimposing effect for the image based on the image capturing date information of the image currently displayed on the monitor 20. More specifically, the MPU 16 sets a cartoon character that effectively emphasizes the date an image was captured as a moving object of a moving image. After the first moving image superimposing effect is set for the image in step S123, a moving image such as that shown in FIG. 26 is displayed on the monitor 20 in the moving image display step of the moving image superimposing routine. This superimposes the moving image on the currently displayed image. In the example shown in FIG. 26, the date of the image currently displayed on the monitor 20 is the 25th of December, which can be associated with Santa Clause. In this case, a cartoon character 87 dressed as Santa Clause is superimposed as a moving image on the image.

When determining that the metadata of the image currently displayed on the monitor 20 does not include an image capturing date in step S121 (NO in step S121) or when determining that the image capturing date of the image currently displayed on the monitor 20 does not conform to any registered date in step S122 (NO in step S122), the MPU 16 proceeds to step S124.

In step S124, the MPU 16 sets a second moving image superimposing effect, which is a moving image superimposing effect used for normal images, for the image. More specifically, the MPU 16 sets a normal cartoon character as a moving object of a moving image. After the second moving image superimposing effect is set for the image in step S124, an image of the normal cartoon character is displayed on the monitor 20 in the moving image display step of the moving image superimposing routine. This superimposes the moving image on the currently displayed image.

The eighth embodiment has the advantage described below in addition to advantages (1) to (10) of the first embodiment and advantage (12) of the third embodiment.

(19) The image processor changes the moving image superimposing effect in accordance with the date an image was captured. Thus, the image processor can add a wide variety of moving image superimposing effects on various images, each captured on different dates.

It should be apparent to those skilled in the art that the present invention may be embodied in many other specific forms without departing from the spirit or scope of the invention. Particularly, it should be understood that the present invention may be embodied in the following forms. The above embodiments may be modified in the following forms.

In the above embodiments, when an image includes a plurality of facial areas 26, the MPU 16 may set the path in which the cartoon character 24 moves so that the cartoon character 24 passes by some of the facial areas 26. In this case, for example, the MPU 16 may compare the size of each facial area 26 in the image and set the path in which the cartoon character 24 moves so that the cartoon character 24 passes by human subjects from those having larger facial areas 26. When the movement path of the cartoon character 24 is set in such a manner, a moving image is superimposed on an image that is displayed on the monitor 20 as described below.

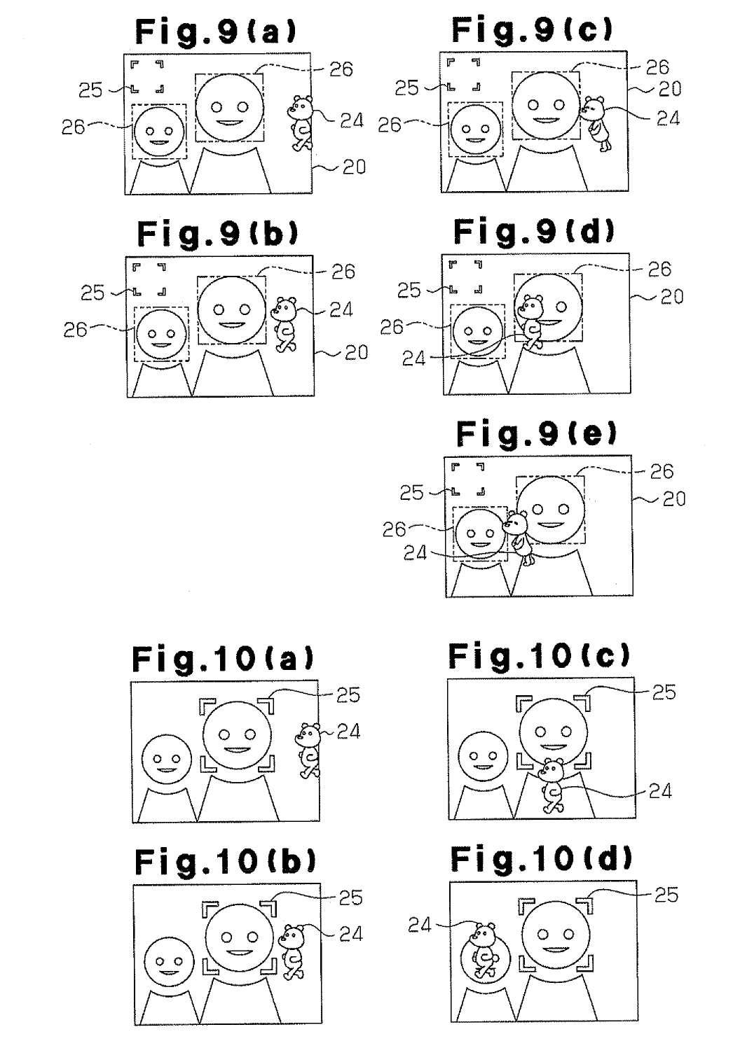

Referring to FIG. 9(a), the cartoon character 24, which faces to the left, first appears at a peripheral portion of the image horizontally rightward from the facial position of a first subject, which has the largest facial area 26 as indicated by its facial information. Then, as shown in FIG. 9(b), the cartoon character 24 continuously moves horizontally leftward to the facial position of the first subject while maintaining its left-facing posture. As shown in FIG. 9(c), when the cartoon character 24 reaches the facial position of the first subject area, the cartoon character 24 moves its face to the facial position of the first subject. Subsequently, as shown in FIG. 9(d), the cartoon character 24 moves downward to the level of the facial position of a second subject, which has the second largest facial area 26 as indicated by its facial information, and then continuously moves horizontally rightward to the facial position of the second subject. Afterward, as shown in FIG. 9(e), the cartoon character 24 moves its face to the position of the second subject.

In this case, the action of the cartoon character 24 for each subject may be changed in accordance with the size of the corresponding facial area 26.

In the above embodiments, when an image includes a facial area 26, the MPU 16 may set the path in which the cartoon character 24 moves so that the cartoon character 24 avoids the position of a feature in the image. By setting the movement path of the cartoon character 24 in this manner, a moving image may be superimposed on an image displayed on the monitor 20 as described below.

As shown in FIG. 10(a), the cartoon character 24, which faces to the left, first appears at a peripheral portion of the image horizontally rightward from the AF area 25. As shown in FIG. 10(b), the cartoon character 24 continuously moves horizontally leftward to the AF area 25 while maintaining its left-facing posture. As shown in FIG. 10(c), when the cartoon character 24 reaches the AF area 25, the cartoon character 24 moves downward to avoid the AF area 25. Subsequently, as shown in FIG. 10(d), the cartoon character 24 continuously moves horizontally leftward away from the AF area 25.

In the above embodiments, a plurality of cartoon characters 24 may be displayed on the monitor 20. In this case, the features used to set the movement path or action of each character 24 may differ in accordance with the type of the character 24 or be the same regardless of the type of the character 24.

In the above embodiments, the MPU 16 may generate a moving image file so cartoon characters 24 moves one after another along the movement path set based on the position information of the feature in the image.

In the above embodiments, the direction of the line of sight of a human subject or the position of a facial part of the human subject may be used as the analysis information of the image information used to detect a feature in an image. In this case, the path in which the cartoon character 24 moves may be changed in accordance with such analysis information. Further, the facial expression, gender, and age of a human subject may be used as the analysis information of the image information. In this case, the movement of the cartoon character 24 with respect to the position of the human subject's face may be changed in accordance with such analysis information.

In the above embodiments, the moving image superimposed on a reproduced image is not limited to a moving object such as the cartoon character 24. For example, a moving image may be generated by performing a blurring process on the information of an image so that the image is blurred around a feature and the blurred portion gradually enlarges. Such a moving image may be superimposed on the reproduced image.

In the third to eighth embodiments, the first image analysis and the second image analysis may be performed when an image is captured.

In the third embodiment, a cartoon character of which color is the same as the color having the highest occupation ratio in the entire image may be used as a cartoon character functioning as the moving object of the moving image.

In the third embodiment, an image may be divided into a plurality of image areas, and the color with the highest occupation ratio in each image area may be analyzed. The color of the cartoon character passing through each image area may then be changed in accordance with the analysis result obtained for each image area.

In the fourth embodiment, scene information used to change the moving image superimposing effect for an image is not limited to information indicating “night scene portrait”, “ocean”, and “snow”. Information indicating any other scene may be used as the scene information.

In the above embodiments, an image that is to undergo the moving image superimposing process is not limited to a still mage and may be a moving image or a through-the-lens image. An image processor that generates a moving image superimposed on an image may be, for example, a video camera, a digital photo frame, a personal computer, or a video recorder. In such cases, an image processing program for performing the image processing may be transferred to the image processor through the Internet or may be stored in a recording medium, such as a CD, which is inserted into the image processor.

A feature of an image is not limited to the AF area 25, the facial area 26, the object area 76, and the string area 78.

Technical concepts according to the present invention that may be recognized from the above embodiments in addition to the appended claims will now be described.

(A) The image processor according to claim 1 or 11, wherein the image is a still image.

(B) The image processor according to claim 1 or 11, wherein the moving image is superimposed on the image currently displayed.

(C) The image processor according to claim 1 or 11, further comprising:

a file generation unit that generating an image file of the moving image;

wherein the moving image generation unit superimposes the moving image on the image by reading the image file of the moving image generated by the moving image file generation unit.

(D) The image processor according to technical concept C, further comprising a moving image file recording unit that records the image file of the moving image generated by the moving image file generation unit in association with the image.

(E) The image processor according to technical concept D, wherein the moving image file recording unit is a nonvolatile recording medium.

What is claimed is:

1. An image processor comprising:
an acquisition unit that acquires image analysis information of a feature in an image; and
a moving image generation unit that generates a moving image superimposed and displayed on the image so that the moving image is displayed in a pattern that changes in accordance with the image analysis information acquired by the acquisition unit.

2. The image processor according to claim 1, wherein when the image includes a plurality of features, the moving image generation unit selects, from the plurality of features, a feature that is given priority in accordance with the image analysis information when generating the moving image.

3. The image processor according to claim 1, wherein:
the image analysis information includes a plurality of information elements respectively corresponding to a plurality of image analyses; and
the moving image generation unit selects, from the plurality of information elements, an information element that is given priority in accordance with a type of the moving image when generating the moving image.

4. The image processor according to claim 1, wherein the moving image generation unit changes, in accordance with the image analysis information, a path in which a moving object of the moving image moves superimposed and displayed on the image.

5. The image processor according to claim 4, wherein the moving image generation unit sets the moving path of the moving object moves so that the moving object passes by a feature in the image.

6. The image processor according to claim 5, wherein when the image includes a plurality of features, the moving image generation unit selects, from the plurality of features, at least one feature that the moving object passes by in accordance with the image analysis information.

7. The image processor according to claim 6, wherein the moving image generation unit selects a plurality of features that the moving object passes by in accordance with the image analysis information and sets an order of the selected plurality of features that the moving object passes by in accordance with the image analysis information.

8. The image processor according to claim 1, wherein the moving image generation unit changes, in accordance with the image analysis information, an appearance of a moving object of the moving image superimposed and displayed on the image.

9. The image processor according to claim 8, wherein:
the feature information includes a ratio of the image occupied by a color; and
the moving image generation unit changes the appearance of the moving object in accordance with the ratio of the image occupied by the color and acquired by the acquisition unit.

10. The image processor according to claim 8, wherein:
the feature information includes scene information of the image; and
the moving image generation unit changes the appearance of the moving object in accordance with the scene information of the image acquired by the acquisition unit.

11. An image processor comprising:
an acquisition unit that obtains feature information of a feature in an image; and
a moving image generation unit that generates a moving image superimposed and displayed on the image so that the moving image is displayed in a pattern that changes in accordance with the feature information acquired by the acquisition unit.

12. The image processor according to claim 11, wherein:
the feature information includes image analysis information; and
the moving image generation unit changes the display pattern of the moving image in accordance with the image analysis information acquired by the acquisition unit.

13. The image processor according to claim 12, wherein:
the image analysis information includes a plurality of information elements respectively corresponding to a plurality of image analyses; and
the moving image generation unit selects, from the plurality of information elements, an information element that is given priority in accordance with a type of the moving image when generating the moving image.

14. The image processor according to claim 11, wherein the moving image generation unit changes, in accordance with the feature information, a path in which a moving object of the moving image moves superimposed and displayed on the image.

15. The image processor according to claim 14, wherein the moving image generation unit sets the moving path of the moving object moves so that the moving object passes by a feature in the image.

16. The image processor according to claim 15, wherein when the image includes a plurality of features, the moving image generation unit selects, from the plurality of features, at least one feature that the moving object passes by in accordance with the image analysis information.

17. The image processor according to claim 16, wherein the moving image generation unit selects a plurality of features that the moving object passes by in accordance with the image analysis information and sets an order of the selected plurality of features that the moving object passes by in accordance with the image analysis information.

18. The image processor according to claim 11, wherein the moving image generation unit changes, in accordance with the feature information, an appearance of a moving object of the moving image superimposed and displayed on the image.

19. The image processor according to claim 18, wherein:
the feature information includes a ratio of the image occupied by a color; and
the moving image generation unit changes the appearance of the moving object in accordance with the ratio of the image occupied by the color and acquired by the acquisition unit.

20. The image processor according to claim 18, wherein:
the feature information includes scene information of the image; and
the moving image generation unit changes the appearance of the moving object in accordance with the scene information of the image acquired by the acquisition unit.

21. An electronic camera comprising:
an imaging unit that captures an image; and
the image processor according to claim 1.

22. The electronic camera according to claim 21, wherein the moving image generation unit generates the moving image when the imaging unit captures the image.

23. The electronic camera according to claim 21, further comprising:
a reproduction unit that reproduces an image captured by the imaging unit;
wherein the moving image generation unit generates the moving image when the reproduction unit reproduces the image.

24. An electronic camera comprising:
an imaging unit that captures an image; and
the image processor according to claim 11.

25. The electronic camera according to claim 24, wherein the moving image generation unit generates the moving image when the imaging unit captures the image.

26. The electronic camera according to claim 24, further comprising:
a reproduction unit that reproduces an image captured by the imaging unit;
wherein the moving image generation unit generates the moving image when the reproduction unit reproduces the image.

27. An image processing computer program executed by an image processor that superimposes and displays a moving image on an image, the image processing computer program when executed having the image processor to execute actions comprising:
an acquisition step of acquiring information of the image; and
a moving image generation step of generating the moving image superimposed and displayed on the image so that the moving image is displayed in a pattern that changes in accordance with the feature acquired in the acquisition step.
